(19) United States
(12) Patent Application Publication
(10) Pub. No.: US 2013/0061134 A1
(43) Pub. Date: Mar. 7, 2013

(54) Storage Device Storing Page Processing Program and Information Processing Apparatus

(71) Applicant: Hirotoshi Maehira, Nagoya-shi (JP)

(72) Inventor: Hirotoshi Maehira, Nagoya-shi (JP)

(73) Assignee: BROTHER KOGYO KABUSHIKI KAISHA, Nagoya-shi (JP)

(21) Appl. No.: 13/543,274

(22) Filed: Jul. 6, 2012

(30) Foreign Application Priority Data
Sep. 1, 2011 (JP) 2011-190651

(51) Int. Cl. G06F 17/00

(52) U.S. Cl. 715/251

(57) ABSTRACT

A storage device may store a page processing program that, when executed, causes an information processing apparatus to perform a series of steps. The steps may include acquiring information indicating pages to be printed on successive back and front sides of separate recording media, and associating, based on the acquired information, a top page of a first page group including the pages with a front side or a back side of a recording medium such that the pages is set to be printed on successive back and front sides of separate recording media. The steps may further include determining whether the top page has been associated with a back side of a recording medium and inserting a page at a top of the first page group in a case that the top page is determined to be associated with the back side of the recording medium.

### CROSS REFERENCE TO RELATED APPLICATION

This application claims priority from Japanese Patent Application No. 2011-190651 filed on Sep. 1, 2011, which is incorporated herein by reference.

### TECHNICAL FIELD

The disclosure relates to a technique for performing duplex printing of a plurality of pages arranged in a printing order in a manner such that the pages are divided into two or more page groups.

### BACKGROUND

Known information processing apparatuses, upon performing duplex printing of a book file formed of a plurality of pages in units of chapters, prevent pages of different chapters from being printed on front and back sides of one sheet by selecting “Use new sheet” in a chapter break designation setting.

### SUMMARY

A plurality of pages constituting a book file may include paired pages that form one image in a spread when the first page of the paired pages is printed on a back side of a sheet and the second page of the paired pages is printed on a front side of a next sheet.

In the case of performing duplex printing of such a book file, if a top page of a page group, for example a chapter, is to be printed on a back side of a sheet, the top page of the page group is printed on a front side of a new sheet. Then, the pages constituting the chapter are not printed on the intended sides of sheets, so that the form of a spread cannot be maintained.

Aspects of the present disclosure provide a technique that can maintain the form of a spread in the case of performing duplex printing of a page group including a two-page spread.

### BRIEF DESCRIPTION OF THE DRAWINGS

For a more complete understanding of the disclosure, reference now is made to the following descriptions taken in connection with the accompanying drawings.

FIG. 1 is a block diagram depicting a configuration of a printing system according to a first illustrative embodiment;

FIG. 2 is a schematic diagram depicting an example of a plurality of pages;

FIG. 3 is a schematic diagram for depicting a blank page insertion/output process;

FIG. 4 is a flowchart depicting a flow of the blank page insertion/output process according an illustrative aspect of the present disclosure;

FIG. 5 is a schematic diagram depicting an illustrative break position designation screen;

FIG. 6 is a schematic diagram depicting a flow of a break position designation in time sequence according an illustrative aspect of the present disclosure;

FIG. 7 is a schematic diagram depicting an illustrative two-page spread designation screen;

FIG. 8 is a flowchart depicting a flow of a blank page insertion process according an illustrative aspect of the present disclosure;

FIG. 9 is a schematic diagram depicting an illustrative preview screen;

FIG. 10 is a flowchart depicting a flow of a blank page insertion/output process according to a second illustrative embodiment;

FIG. 11 is a block diagram depicting a configuration of a printing system according to a third illustrative embodiment;

FIG. 12 is a flowchart depicting a flow of a PC scanning process according an illustrative aspect of the present disclosure;

FIG. 13 is a flowchart depicting a flow of a blank page insertion/output process according to a fourth illustrative embodiment; and

FIG. 14 is a flowchart depicting a flow of a blank page recovery process according an illustrative aspect of the present disclosure.

### DETAILED DESCRIPTION

### First Embodiment

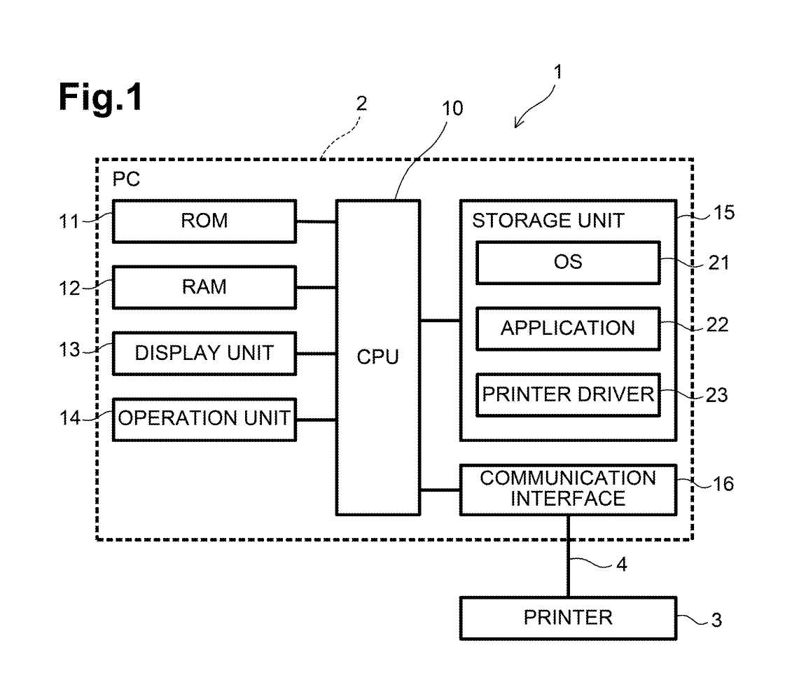

A first illustrative embodiment now is described in detail with reference to FIGS. 1 through 9.

(1) Configuration of Printing System

As shown in FIG. 1, a printing system 1 may include a personal computer (PC) 2, and a printer 3. PC 2 and printer 3 may be communicably connected to each other through a communication network 4, e.g., a LAN (Local Area Network) or the Internet. PC 2 may transmit printing data to printer 3 through communication network 4. Then, printer 3 may print the printing data received from PC 2 on a sheet such as printing paper.

PC 2 may include a CPU 10, a ROM 11, a RAM 12, a display unit 13, an operation unit 14, a storage unit 15, and a communication interface 16.

CPU 10 may control components of PC 2 by executing various types of programs stored in ROM 11 and storage unit 15. ROM 11 may store various types of programs that may be executed by CPU 10. RAM 12 may be used as a primary storage device such that CPU 10 executes various processes.

Display unit 13 may include a display device, e.g., a liquid crystal display, and a drive circuit that drives the display device.

Operation unit 14 may include input devices, e.g., a mouse and a keyboard.

Storage unit 15 may store various types of programs and data using nonvolatile memories, e.g., a hard disk and a flash memory. Storage unit 15 may store an operating system (OS) 21, application programs 22, e.g., a word processor, a spreadsheet program, and an image editing program. It should be noted that application program 22 is abbreviated as “APPLICATION” in FIG. 1.

Communication interface 16 may be communicably connected to printer 3 through communication network 4, e.g., a LAN, a USB (Universal Serial Bus), and a parallel line.

Printer 3 may print an image represented by the printing data received from PC 2 onto a sheet using an electrographic system, an ink jet system, or the like. Printer 3 may be configured to be capable of performing duplex printing for printing images on a front side and a back side of a sheet.

(2) Two-Page Spread

A user can create a document including a plurality of pages by using PC 2 running a word processor, and request duplex printing of the created document, for example.

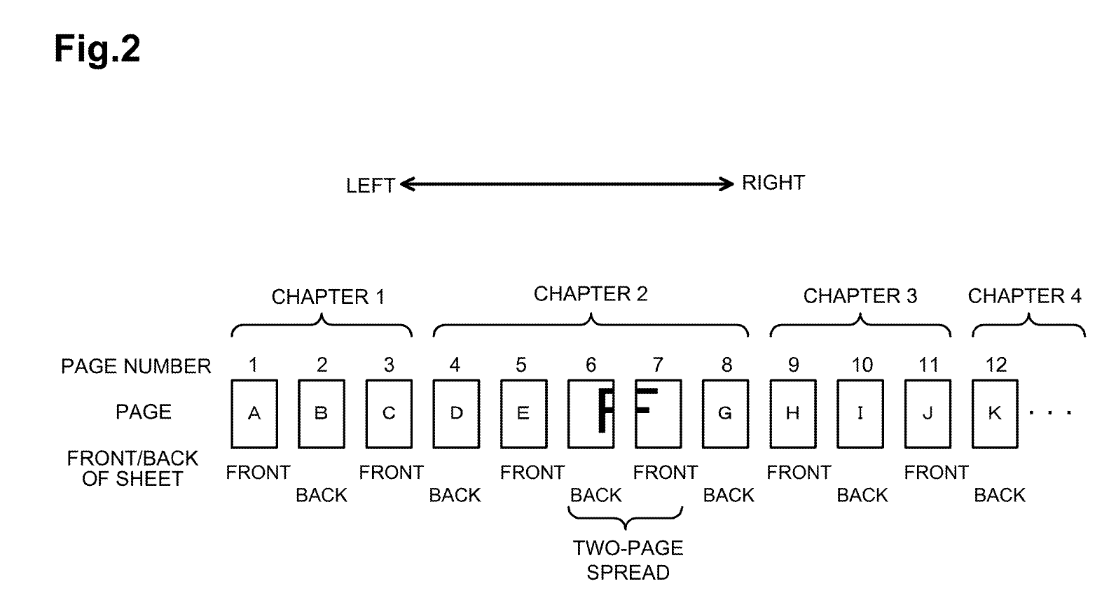

As shown in FIG. 2, a document may include a plurality of pages which are arranged in the printing order from the left to the right. The document shown in FIG. 2 may include four chapters of chapter 1 through chapter 4.

If the pages shown in FIG. 2 are printed on both sides of sheets and the printed sheets are bound, page 6 and page 7 of chapter 2 form one character “F” in a spread. The term “bind” as used herein indicates binding of sheets into a booklet. More specifically, sheets may be stacked with their odd-numbered pages facing up so as to be arranged in the printing order from top to bottom. The stacked sheets may be bound along the left edges of their odd-numbered pages. A pair of pages (page 6 and page 7) that forms one image in a spread when bound into a booklet may be referred to as a two-page spread. That is, a two-page spread may include two pages.

In the case where duplex printing of a plurality of pages is performed, the work of checking the printing result may be shared by a plurality of persons. For example, the printing result may be divided into separate booklets in units of chapters, and the booklets of the different chapters may be checked by different persons. In the case of FIG. 2, if duplex printing of a plurality of pages is performed in one batch, a last page (page 3) of chapter 1 and a top page (page 4) of chapter 2 may be printed on a front side and a back side, respectively, of one sheet. Accordingly, the printing result of chapter 1 and the printing result of chapter 2 cannot be completely separated from each other.

In order to solve this problem, a blank page insertion/output process may be executed. A blank page may be inserted so as to, if duplex printing of a plurality of pages is performed, maintain the form of a spread while preventing the pages of different chapters from being printed on front and back sides of one sheet.

The term “blank page” as used herein indicates a page on which nothing is printed when the page may be printed on a sheet. A description now is given of an example in which a blank page is inserted. The page to be inserted is not limited to a blank page. For example, a page with the text “blank” may be inserted. The content of the page to be inserted may be selected appropriately.

(3) Blank Page Insertion/Output Process

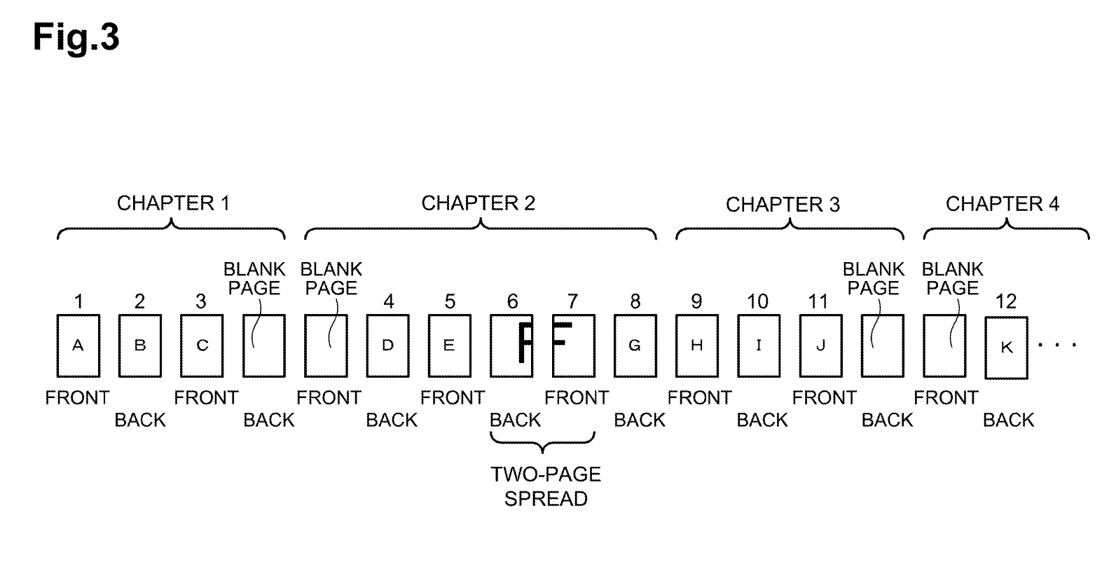

FIG. 3 may depict a result in which blank pages are inserted into the plurality of pages shown in FIG. 2. An overview of the blank page insertion/output process now is described with reference to FIG. 3.

Insertion of a blank page may be performed by CPU 10 running printer driver 23 (hereinafter, simply referred to as “printer driver 23”). If a user requests a printing operation through application program 22 such as a word processor, a plurality of pages may be output from application program 22 to printer driver 23 through OS 21. When the pages are output, printer driver 23 may divide the output plurality of pages into chapters, and may receive a designation of a two-page spread made by a user.

The printer driver 23 may determine, on the basis that the first page (page 6) of two pages constituting a two-page spread (pages 6 and 7) designated by the user is to be printed on a back side of a sheet and the second page (page 7) of the two pages is to be printed on a front side of a next sheet, whether a top page of each chapter is to be printed on a back side of a sheet.

For example, in the case of chapter 2, on the basis that page 6 may be printed on a back side of a sheet and page 7 may be printed on a front side of a next sheet, page 4 of chapter 2 is to be printed on a back side of a sheet.

In the case where a top page of a chapter is to be printed on a back side of a sheet, printer driver 23 may insert a blank page before the top page. If duplex printing of the plurality of pages is performed in one batch, the inserted blank page may be printed on a back side of a sheet on whose front side a last page of chapter 1 may be printed. As a result, the top page of chapter 2 may be printed on a front side of a new sheet. Thus, the printing result of chapter 1 and the printing result of chapter 2 can be separated from each other.

In the case where page 4 of chapter 2 is printed on a front side of a sheet, page 6 may be printed on a front side of a sheet, and page 7 may be printed on a back side of the same sheet, so that the form of a spread cannot be maintained.

To solve this problem, in the case where a last page of a chapter may be printed on a front side of a sheet, printer driver 23 may insert a blank page after the last page of the chapter. In this way, a blank page may be inserted after page 3 of chapter 1, so that page 4 of chapter 2 may be printed on a back side of a sheet. It may be possible to maintain the form of a spread while preventing the last page of chapter 1 and the top page of chapter 2 from being printed on a front side and a back side, respectively, of one sheet.

Similarly, as for chapter 3 and chapter 4, it can be determined whether a top page of each chapter is to be printed on a back side of a sheet on the basis that the first page of the pages constituting a two-page spread is to be printed on a back side of a sheet and the second of the pages is printed on a front side of a next sheet.

For example, in the case of chapter 3, since page 9 is to be printed on a front side of a sheet, no blank page may be inserted before page 9 of chapter 3. Further, the fact that page 9 of chapter 3 is to be printed on a front side of a sheet may indicate that page 8 of chapter 2 is to be printed on a back side of the sheet. In other words, since page 8 of chapter 2 is not to be printed on a front side of a sheet, insertion of a blank page after the last page of chapter 2 may not be performed.

On the other hand, if page 12 of chapter 4 is to be printed on a back side of a sheet, printer driver 23 may insert a blank page before page 12 of chapter 4. Accordingly, in this case, another blank page may be inserted after page 11 of chapter 3.

(3-1) Flow of Blank Page Insertion/Output Process

A blank page insertion/output process may start when a plurality of pages are output from application program 22 to printer driver 23 through OS 21.

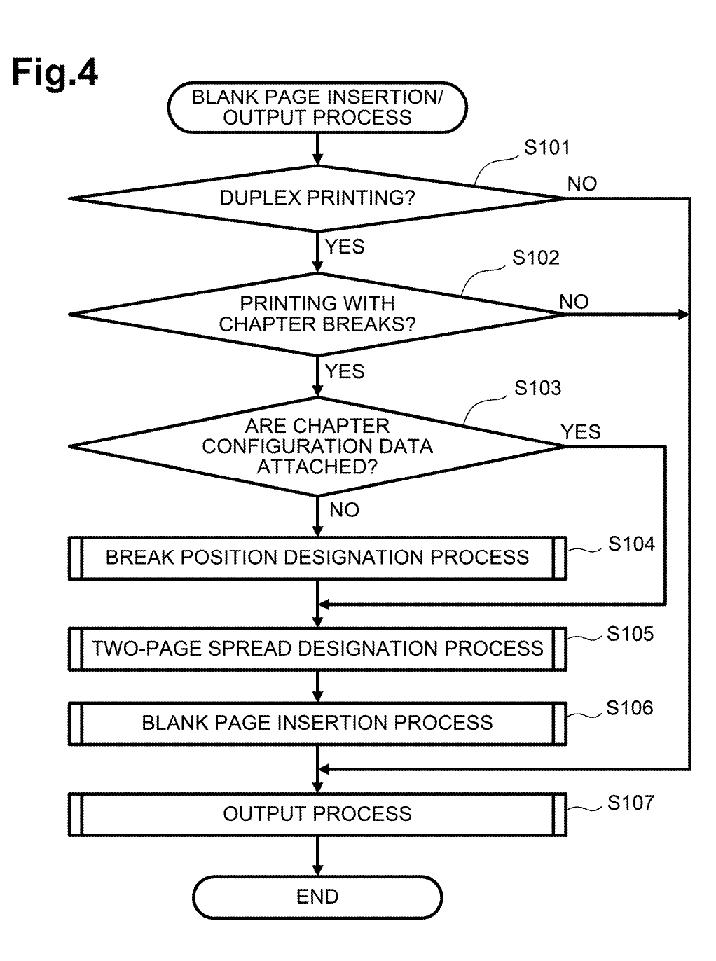

As shown in FIG. 4, in Step S101, printer driver 23 may determine whether duplex printing is selected. More specifically, a user can select in advance whether to perform duplex printing of the plurality of pages on a printing setting screen displayed by application program 22, or a printing setting screen displayed by printer driver 23. If duplex printing is selected, printer driver 23 may proceed to Step S102. If duplex printing is not selected, printer driver 23 may proceed to Step S107.

In Step S102, printer driver 23 may determine whether printing with chapter breaks is selected. The term “printing with chapter breaks” as used herein indicates that, in the case of performing duplex printing of a plurality of pages, duplex printing may be performed so as not to print pages of different chapters on both sides of one sheet.

The user may select in advance whether to perform printing with chapter breaks in the above-described printing setting screen. If printing with chapter breaks is selected, printer driver 23 may proceed to Step S103. If not, printer driver 23 may proceed to Step S107.

In Step S103, printer driver 23 may determine whether chapter configuration data are attached to the plurality of pages. The chapter configuration data may contain information indicating that pages 1-3 form chapter 1, and pages 4-8 form chapter 2.

Application program 22 may be configured to output to printer driver 23 the plurality of pages with the above-described chapter configuration data of the plurality of pages attached thereto. If a plurality of pages are output from application program 22 having such a configuration, chapter configuration data may be attached to the plurality of pages.

If chapter configuration data are not attached, printer driver 23 may proceed to Step S104. If chapter configuration data are attached, printer driver 23 may proceed to Step S105.

In Step S104, printer driver 23 may execute a break position designation process of receiving a designation of chapter break positions made by the user.

In Step S105, printer driver 23 may execute a two-page spread designation process of receiving a designation of a two-page spread made by the user.

In Step S106, printer driver 23 may execute a blank page insertion process of inserting a blank page into the plurality of pages.

In Step S107, printer driver 23 may execute an output process of outputting the plurality of pages with the blank page inserted therein.

The blank page insertion/output process may be completed. After completion of this process, if a blank page has been inserted in the plurality of pages, printer driver 23 may generate printing data based on the plurality of pages with the blank page inserted therein. On the other hand, if no blank page has been inserted in the plurality of pages, printer driver 23 may generate printing data based on the plurality of pages without any blank page inserted therein. Then, printer driver 23 may send the generated printing data to printer 3.

(3-2) Break Position Designation Process

In a break position designation process executed in Step S104, a break position designation screen may be displayed to receive a break position designation made by a user.

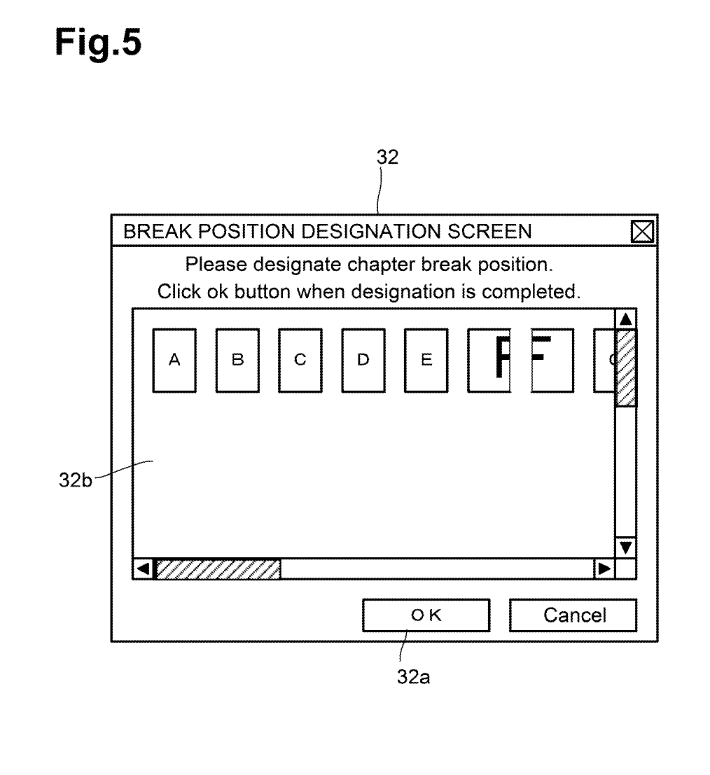

As shown in FIG. 5, a break position designation screen 32 may include a thumbnail display area 32b with thumbnail images corresponding to the pages output from application programs 22. These thumbnail images may be arranged in an order in which the pages corresponding to the thumbnail images are printed.

Break position designation screen 32 can be scrolled vertically and horizontally. A user can designate a position at which pages are to be divided into chapters, i.e., a break position at which pages are to be divided into two or more page groups by clicking on a space between pages on the break position designation screen 32 using a mouse. When the user designates a break position, information indicating the break position may be acquired as break position information by printer driver 23.

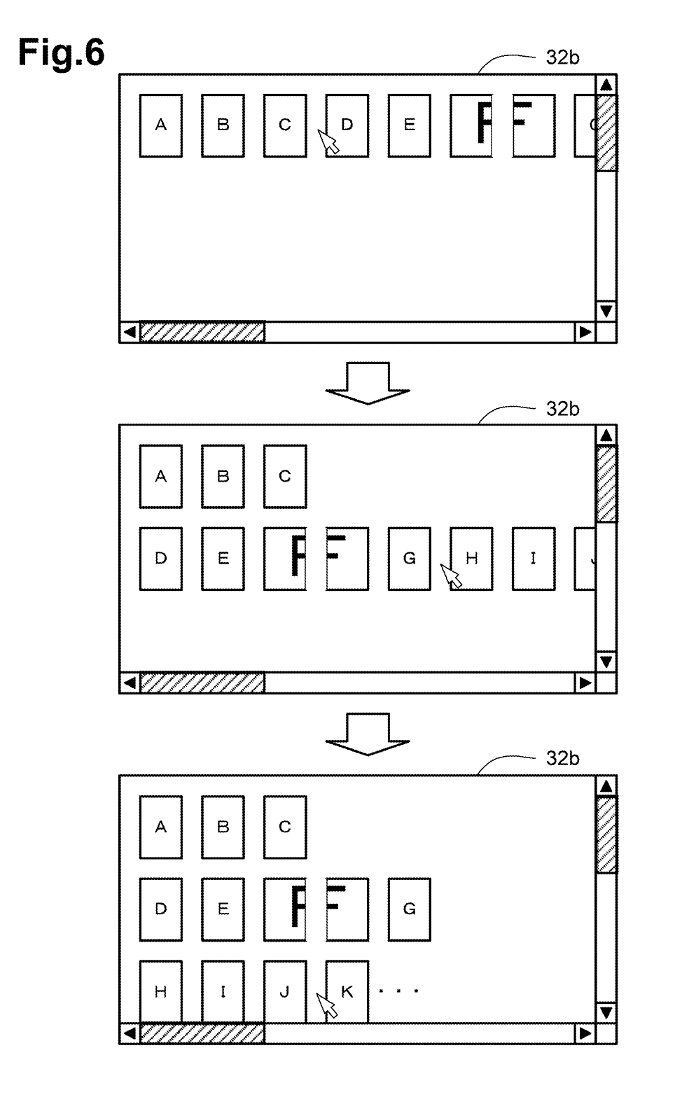

As shown in FIG. 6, when the user designates a break position, the thumbnail images may be displayed with a line break at the designated position. A plurality of break positions may be designated. The user can divide the pages into three or more chapters by repeatedly performing break position designations. When the break position designation is completed, the user may click an OK button 32a shown in FIG. 5.

(3-3) Two-Page Spread Designation Process

In a two-page spread designation process executed in Step S105, a two-page spread designation screen may be displayed to receive a two-page spread designation made by a user.

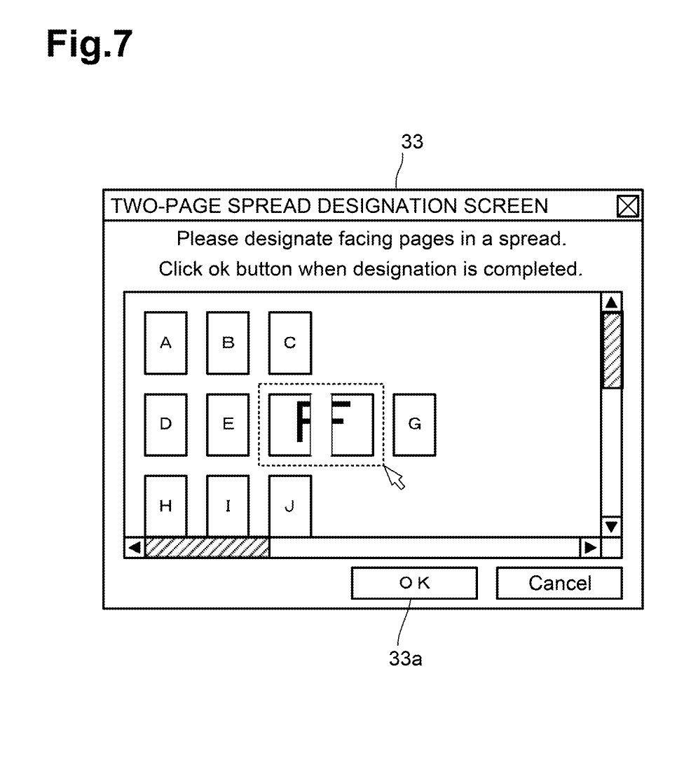

Similar to break position designation screen 32 described above, a two-page spread designation screen 33 may display thumbnail images of the respective pages as shown in FIG. 7. These thumbnail images may be displayed with line breaks between each chapter according to the break positions designated on break position designation screen 32.

The user can designate a two-page spread by clicking on thumbnail images corresponding to two pages that constitute a two-page spread. When the user designates a two-page spread, printer driver 23 may acquire information indicating the two-page spread as two-page spread information. More specifically, printer driver 23 may acquire page numbers of the two pages constituting the two-page spread designated by the user as the two-page spread information.

It should be noted that designation of a two-page spread may be performed using an appropriate method. For example, a two-page spread may be designated by selecting a range of an area where two thumbnail images are displayed by performing a range selection operation of moving a mouse while holding down a right button thereon. When the two-page spread designation is completed, the user may click an OK button 33a.

(3-4) Blank Page Insertion Process

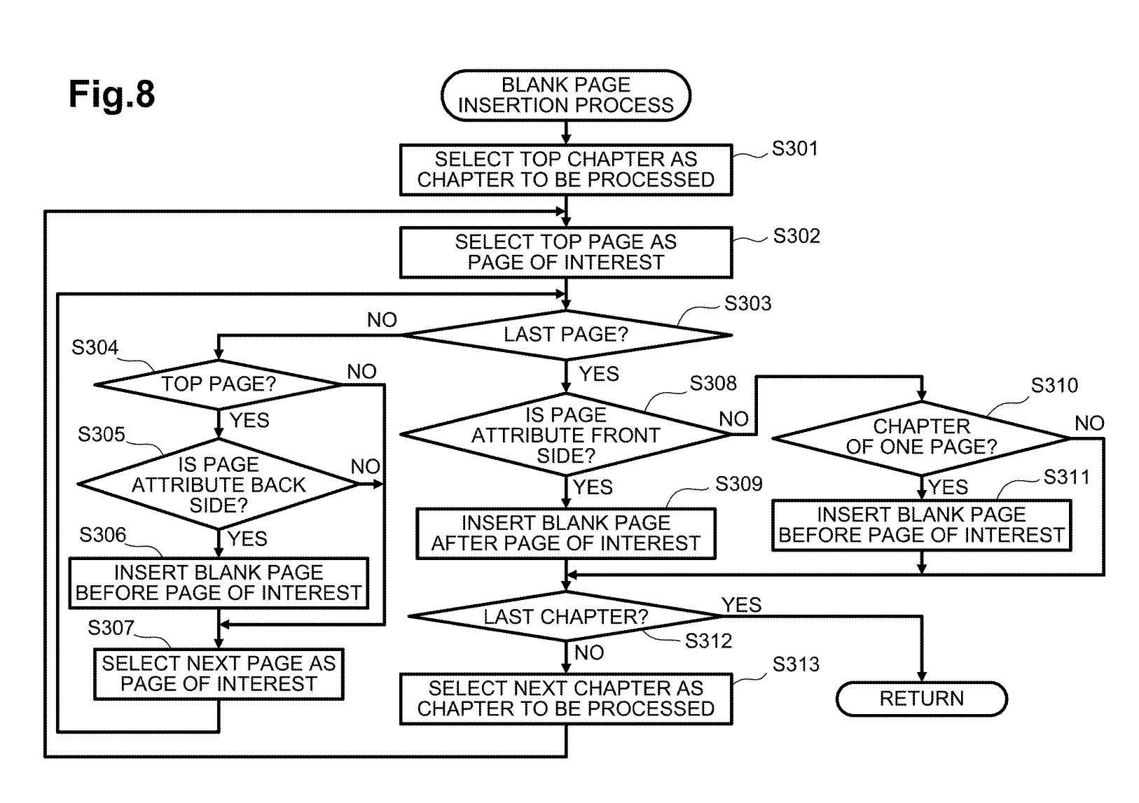

A blank page insertion process executed in Step S106 is now described with reference to FIG. 8.

In Step S301, printer driver 23 may select a top chapter as a chapter to be processed.

In Step S302, printer driver 23 may select a top page of the chapter, which is selected as a chapter to be processed, as a page of interest.

In Step S303, printer driver 23 may determine whether the page of interest is a last page of the chapter. If the page of interest is not a last page, the procedure may proceed to Step S304. If the page of interest is a last page, the procedure may proceed to Step S308.

In Step S304, printer driver 23 may determine whether the page of interest is a top page of the chapter. If the page of interest is a top page, the procedure may proceed to Step S305. If the page of interest is not a top page, the procedure may proceed to Step S307.

In Step S305, printer driver 23 may determine, on the basis that the first page of two pages constituting a pair indicated by the two-page spread information is to be printed on a back side of a sheet and the second page of the two pages is to be printed on a front side of a next sheet, whether a page of interest is to be printed on a back side of a sheet. If the page of interest is to be printed on a back side of a sheet, printer driver 23 may proceed to Step S306. If not, i.e., if the page of interest is to be printed on a front side of a sheet, printer driver 23 may proceed to Step S307.

In Step S306, printer driver 23 may insert a blank page before the page of interest.

In Step S307, printer driver 23 may select a next page as a page of interest.

Steps S308 through S313 described below may be operations performed in the case where the page of interest is determined to be a last page in Step S303.

In Step S308, printer driver 23 may determine, on the basis that the first page of two pages constituting a two-page spread is to be printed on a back side of a sheet and the second page of the two pages is to be printed on a front side of a next sheet, whether a page of interest, i.e., the last page, is to be printed on a back side of a sheet. If the last page is to be printed on a front side of a sheet, printer driver 23 may proceed to Step S309. If not, i.e., if the last page is to be printed on a back side of a sheet, printer driver 23 may proceed to Step S310.

In Step S309, printer driver 23 may insert a blank page after the page of interest. The insertion of a blank page in Step S309 may be performed in the case where the last page of the selected chapter is to be printed on a front side of a sheet. In this case, a top page of a next chapter is to be printed on a back side of the sheet. From the viewpoint of a next chapter, inserting a blank page in S309 may correspond to “inserting, in the case where a top page of the chapter is to be printed on a back side of a sheet, a blank page at the end of a previous chapter”.

In Step S310, printer driver 23 may determine whether a chapter consists of one page. If the chapter consists of one page, the procedure may proceed to Step S311. If not, i.e., if the chapter includes two or more pages, the procedure may proceed to Step S312.

In Step S311, printer driver 23 may insert a blank page before the page of interest.

In Step S312, printer driver 23 may determine whether the chapter selected as a chapter to be processed is the last chapter. If the selected chapter is not the last chapter, the procedure may proceed to Step S313. If the selected chapter is the last chapter, this process may end and the procedure may return to the blank page insertion/output process.

In Step S313, printer driver 23 may select a chapter as a chapter to be processed.

(3-5) Output Process

In an output process executed in Step S107, a preview screen may be displayed to preview a plurality of pages with a blank page inserted therein.

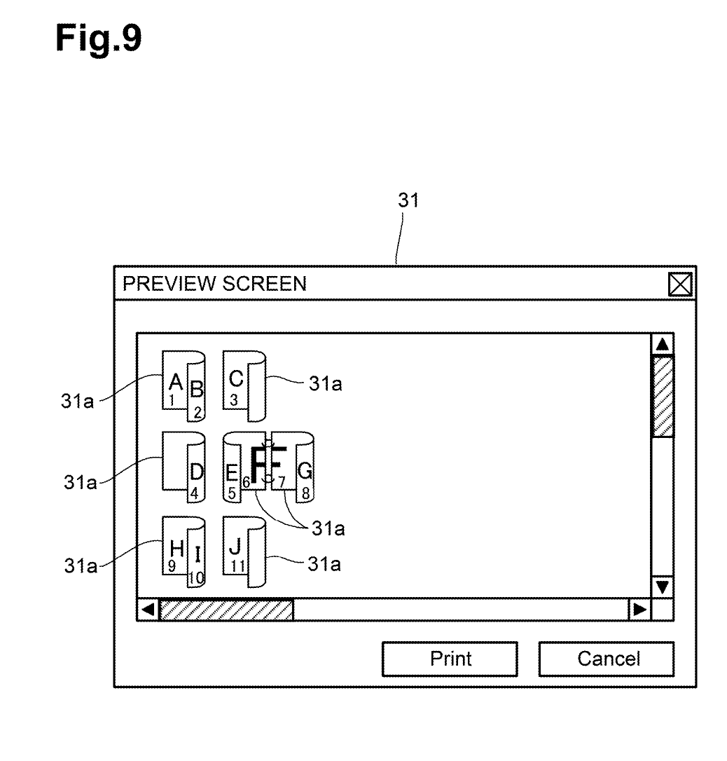

Preview screen 31 shown in FIG. 9 may be displayed in the case where duplex printing is selected and printing with chapter breaks is selected by a user.

Preview screen 31 may display sheet icons 31a with pages to be printed displayed thereon. As shown in FIG. 9, each sheet icon 31a may have a curved shape such that a front side and a back side of a sheet can be viewed at the same time. A user can check a page number of a page to be printed on a front side of a sheet corresponding to sheet icon 31a and a page number of a page to be printed on a back side of the sheet.

If no page number is displayed on the front side or the back side of sheet icon 31a, a blank page inserted by the blank page insertion process may be printed on that side. For example, sheet icon 31a at the left end on line 2 may not show any page number on a front side thereof. Accordingly, a blank page is to be printed on a front side of a sheet represented by sheet icon 31a, and page 4 is to be printed on a back side of the sheet. Sheet icon 31a may display only a page number.

Preview screen 31 may display a two-page spread in an identifiable manner. More specifically, a sheet icon 31a may represent a sheet on which the first page (page 6) of pages constituting a two-page spread is to be printed. Another sheet icon 31a may represent another sheet on which the second page (page 7) of the pages is to be printed. These sheets may be displayed in such a manner that the sheets are linked to each other through two rings. Thus, a user can check the pages constituting the two-page spread on preview screen 31.

(4) Advantageous Effects

According to the first illustrative embodiment described above, printer driver 23 may determine, with respect to all the chapters, on the basis that the first page of two pages constituting a two-page spread is to be printed on a back side of a sheet and the second page of the two pages is to be printed on a front side of a next sheet, whether a top page of a chapter is to be printed on a back side of a sheet. If the top page is to be printed on a back side of a sheet, printer driver 23 may insert a blank page at the top of the chapter, and also may insert a blank page at the end of a previous chapter. In this way, in the case of performing duplex printing of a plurality of pages in one batch, with respect to all the chapters, it may be possible to maintain the form of a spread while preventing the top page of the chapter and the last page of the previous chapter from being printed on front and back sides of one sheet, and preventing the last page of the chapter and a top page of a next chapter from being printed on front and back sides of one sheet.

Further, since printer driver 23 may display the result in which a blank page is inserted in a plurality of pages on preview screen 31, a user can check the result in which the blank page is inserted before performing a printing operation.

### Second Embodiment

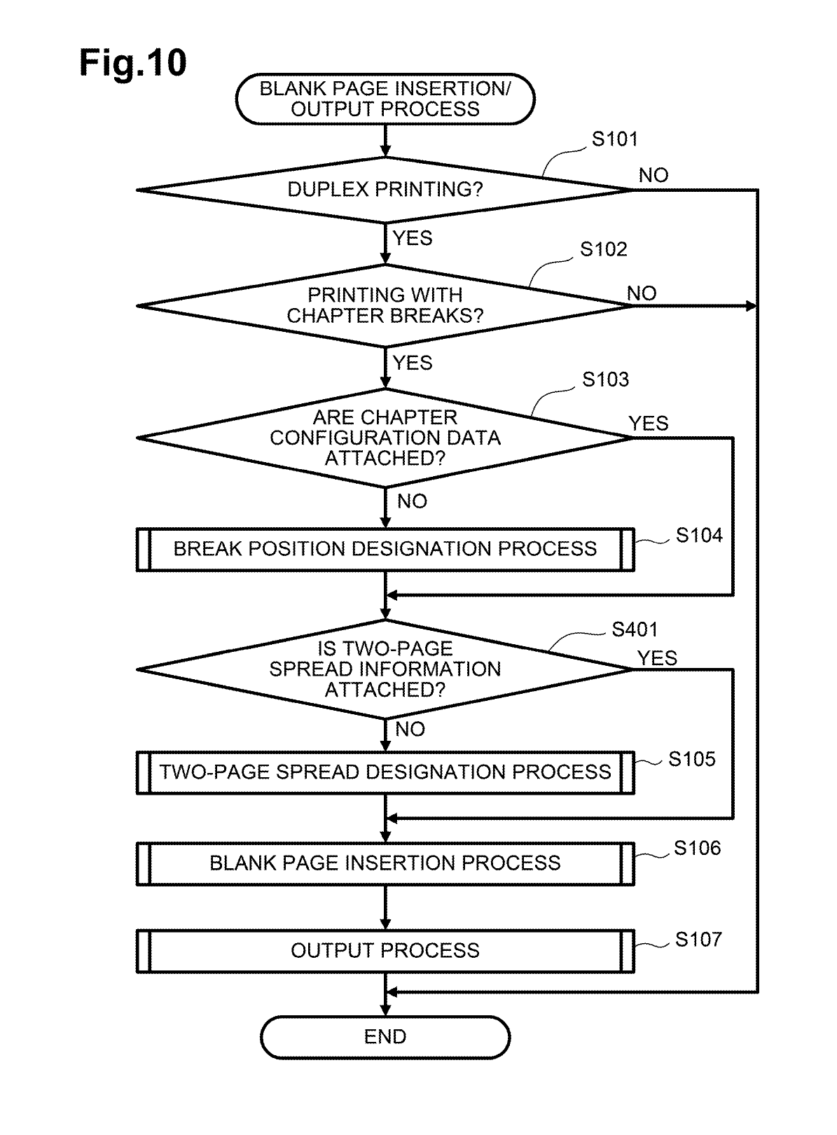

Next, a second illustrative embodiment is now described in detail with reference to FIG. 10.

In the first illustrative embodiment, the description has been given of the example in which a two-page spread designation made by a user may be received in Step S105. In the second illustrative embodiment, if two-page spread information has already been attached to a plurality of pages, the two-page spread information may be acquired from the plurality of pages. If two-page spread information has not been attached to a plurality of pages, two-page spread information may be acquired by receiving a two-page spread designation made by a user. The two-page spread information as used herein may refer to data indicating “pages 6 and 7” in the case where pages 6 and 7 constitute a two-page spread, for instance.

For example, application program 22 may be configured to output to printer driver 23 a plurality of pages with two-page spread information attached thereto. If pages are output from application program 22, two-page spread information may be attached to the output pages.

A blank page insertion/output process of the second illustrative embodiment now is described with reference to FIG. 10. The same processes as those of the first illustrative embodiment may be referred to by the same reference numerals, and a description thereof will be omitted.

A printer driver 23 may determine whether two-page spread information is attached to a plurality of pages in Step S401. If two-page spread information is not attached to the plurality of pages, the procedure may proceed to Step S105. If two-page spread information is attached to the plurality of pages, printer driver 23 may acquire the two-page spread information from the plurality of pages (step not shown), and may proceed to Step S106 after the acquisition.

According to the second illustrative embodiment described above, if two-page spread information is attached to a plurality of pages, printer driver 23 can acquire the two-page spread information from the pages. On the other hand, if two-page spread information is not attached to a plurality of pages, printer driver 23 can acquire two-page spread information by receiving a two-page spread designation made by a user.

### Third Embodiment

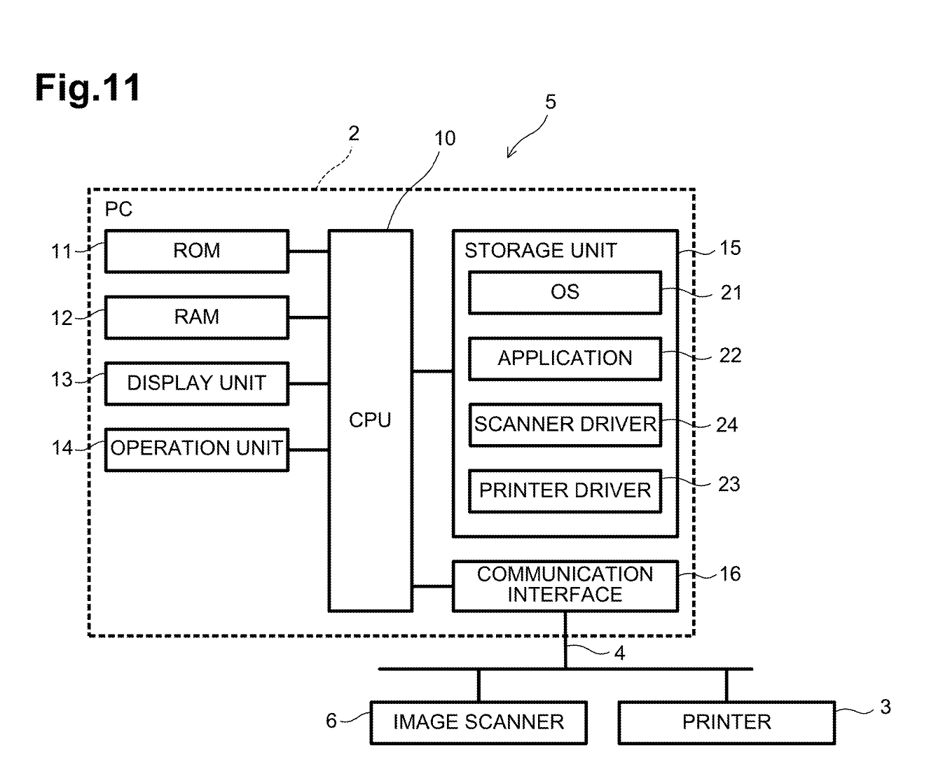

A third illustrative embodiment now is described with reference to FIG. 11.

In the first and second illustrative embodiments, the description has been given of the example in which two-page spread information indicating a pair of pages that forms one image in a spread is acquired, and a determination of whether each page is to be printed on a front side of a sheet or to be a back side of a sheet is made based on the two-page spread information. In the third illustrative embodiment, a determination may be made based on attribute information attached to the pages.

As depicted in FIG. 11, an image scanner 6 of printing system 5 may include an ADF (Auto Document Feeder) that transports originals stacked in a stacker one by one, and a scanning unit that scans both sides of the original being transported by the ADF and generates image data representing the front side of the original and image data representing the back side of the original.

A CPU 10 of a PC 2 of the third illustrative embodiment may perform a so-called PC scanning process by executing a scanner driver 24 that controls image scanner 6. The PC scanning process may be a process of instructing image scanner 6 to scan an original, and acquiring, from image scanner 6, image data that are generated by image scanner 6 by scanning the original.

The image data may be sequentially acquired, starting from the first one of the originals. With respect to each original, image data generated by scanning a front side of the original and image data generated by scanning a back side of the original may be acquired in this order. That is, image data of a front side of the first original, image data of a back side of the first original, image data of a front side of the second original, and image data of a back side of the second original may be acquired by PC 2 in this order.

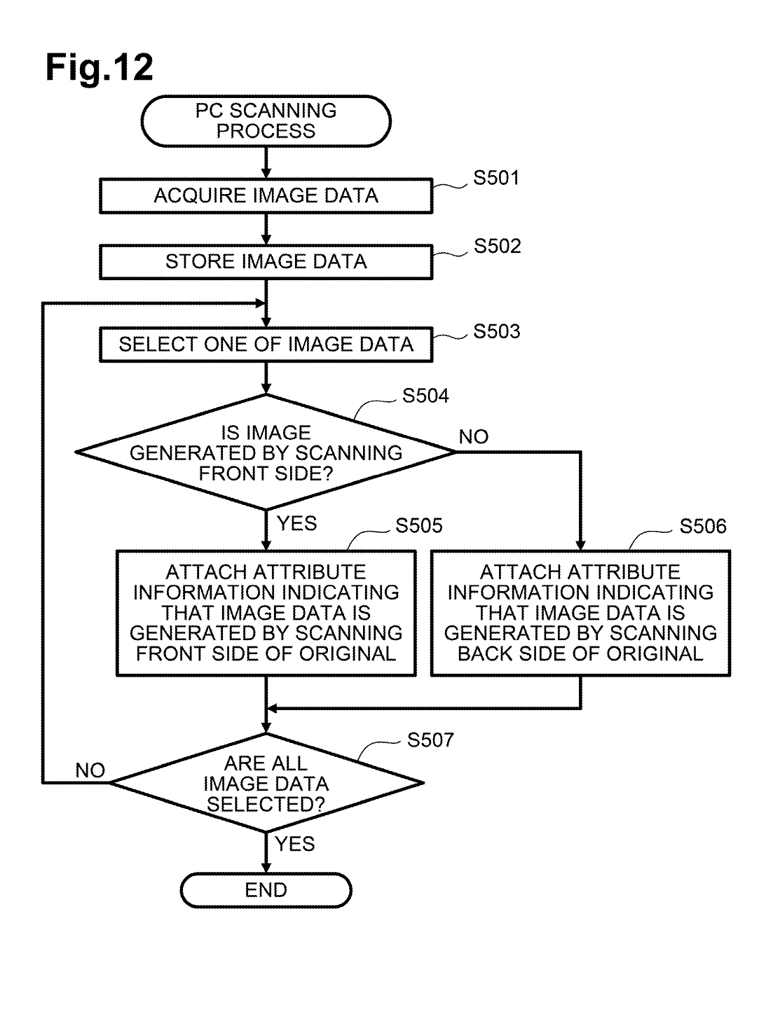

A PC scanning process performed by the CPU 10 running the scanner driver 24 (hereinafter, simply referred to as “scanner driver 24”) is described with reference to FIG. 12. This process may start when a user requests execution of PC scanning by operating operation unit 14 of PC 2.

In Step S501, scanner driver 24 may instruct image scanner 6 to scan an original, and may acquire image data from image scanner 6.

In Step S502, scanner driver 24 may cause storage unit 15 to store a plurality of image data acquired from image scanner 6.

In Step S503, scanner driver 24 may select one of the image data stored in storage unit 15. This selection may be made in the order in which the image data are acquired from image scanner 6.

In Step S504, scanner driver 24 may determine whether the selected image data is either generated by scanning a front side of the original or generated by scanning a back side of the original.

More specifically, scanner driver 24 may determine that the selected image data is generated by scanning a front side if the order in which the selected image data is acquired is an odd number order, and may determine that the selected image data is generated by scanning a back side if the order in which the selected image data is acquired is an even number order.

It should be noted that, depending on the configuration of image scanner 6, a front side of an original may be scanned first, or a back side of an original may be scanned first. Since the order of acquisition of image data corresponds to the order of acquisition of the scanning data items, the order of acquisition of image data may vary depending on the model of the image scanner 6. Scanner driver 24 may acquire the model name or the like of image scanner 6 that has acquired the image data, and may specify front and back sides according to the acquired model name or the like.

If the acquired image data is generated by scanning a front side of the original, scanner driver 24 may proceed to Step S505. If the acquired image data is generated by scanning a back side of the original, scanner driver 24 may proceed to Step 506.

In Step S505, scanner driver 24 may attach, to the acquired image data, attribute information indicating that the acquired image data is generated by scanning a front side of the original.

In Step S506, scanner driver 24 may attach, to the acquired image data, attribute information indicating that the acquired image data is generated by scanning a back side of the original.

In Step S507, scanner driver 24 may determine whether the selection has been made with respect to all the image data. If the selection has been made with respect to all the image data, this process may end. If not, the procedure may return to Step S503 to repeat the above-described operations.

The PC scanning process may be completed. The image data acquired by the PC scanning process may be read from storage unit 15 by CPU 10 running application program 22, and may be output to printer driver 23 through OS 21. When the image data are output, printer driver 23 may execute a blank page insertion/output process using the output image data as a plurality of pages.

The blank page insertion/output process of the third illustrative embodiment may be substantially the same as the blank page insertion/output process of the first illustrative embodiment, except that the two-page spread designation process of Step S105 is not performed.

Further, the blank page insertion process of the third illustrative embodiment may be substantially the same as the blank page insertion process of the first illustrative embodiment, except that a determination of whether each page is to be printed on a front side of a sheet or to be printed on a back side of a sheet is made based on attribute information attached to the page.

In the third illustrative embodiment, however, since a two-page spread is not designated, printer driver 23 cannot determine which pages constitute a two-page spread. Accordingly, in the third illustrative embodiment, the pages constituting a two-page spread cannot be checked on preview screen 31.

According to the third illustrative embodiment described above, if a top page of a chapter is to be printed on a back side of a sheet, the page processing program may insert a blank page at the top of the chapter, and also may insert a blank page at the end of a previous chapter. Thus, it is possible to maintain the form of a spread while preventing the top page of the chapter and the last page of the previous chapter from being printed on front and back sides of one sheet, and preventing a last page of the chapter and a top page of a next chapter from being printed on front and back sides of one sheet.

Further, the page processing program may attach attribute information to image data that is generated by scanning an original. Thus, the page processing program can determine, with respect to each chapter, whether a top page of the chapter is to be printed on a front side.

### Fourth Embodiment

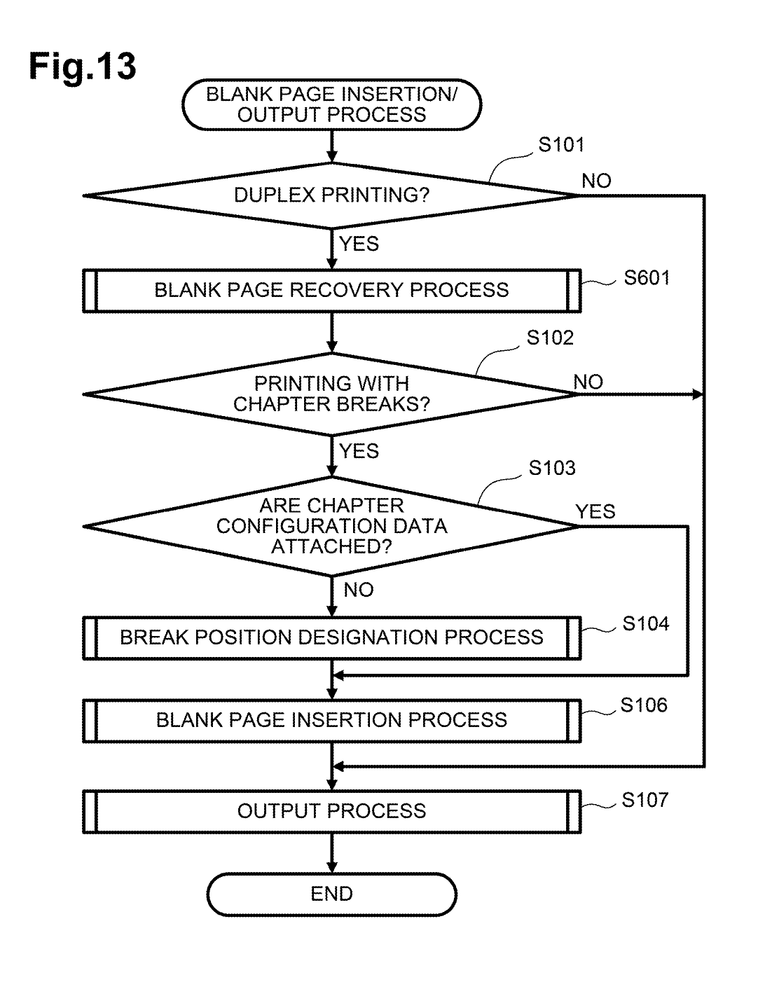

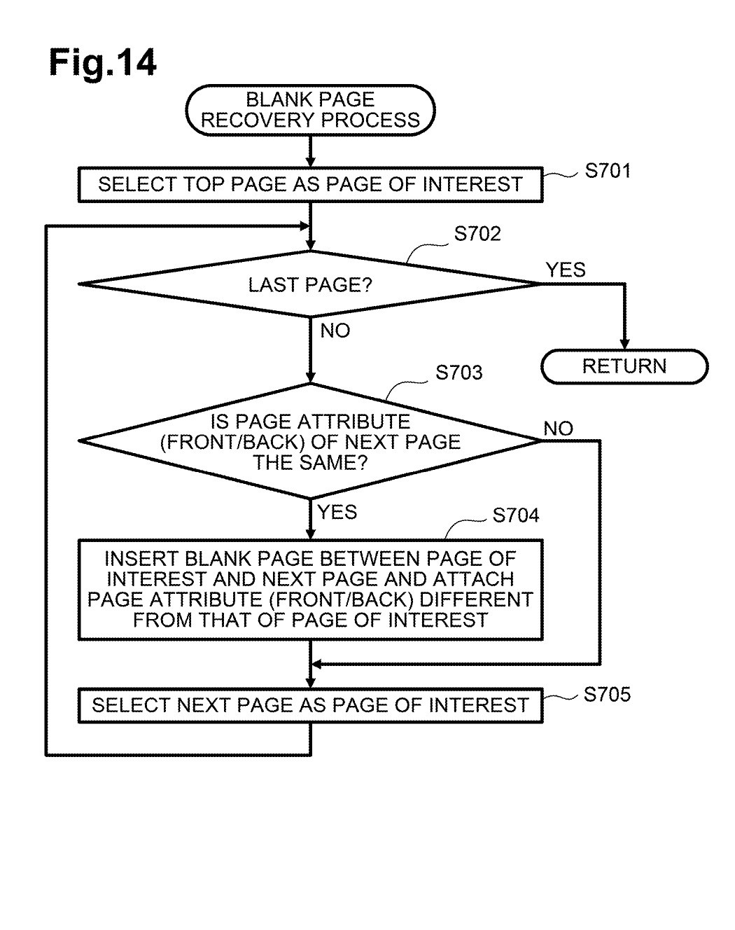

Next, a description of a fourth illustrative embodiment is described with reference to FIGS. 13 and 14.

In the fourth illustrative embodiment, printer driver 23 may execute a blank page recovery process based on a page attribute attached to each page, and may execute the above-described blank page insertion/output process based on the page attribute.

Recovery of a blank page may be different from the above-described insertion of a blank page. Before starting a blank page insertion/output process, a blank page may be removed from pages output from application program 22 in order to prevent wasteful use of sheets. Further, application program 22 may output pages to printer driver 23 after removing blank pages.

However, if a blank page is removed, the pages may not be printed on the intended sides of sheets when duplex printing is performed, so that the form of a spread cannot be maintained. The blank page recovery process may be a process of recovering a removed blank page in order to maintain the form of a spread in the case of performing duplex printing of the pages.

In this illustrative embodiment, when printer driver 23 or application program 22 removes a blank page, a page attribute indicating whether the page is to be printed on a front side of a sheet or to be printed on a back side of a sheet may be attached to each page in a state before removal of the blank page. More specifically, in a state before removal of a blank page, page attributes indicating that the page is to be printed on a front side of a sheet may be attached to odd-numbered pages, and page attributes indicating that the page is to be printed on a back side of a sheet may be attached to even-numbered pages. The reason why these page attributes are attached may be to make it possible to specify the position of the removed page afterward.

FIG. 13 depicts a flow of a blank page insertion/output process according to the fourth illustrative embodiment. As depicted in FIG. 13, if printer driver 23 determines that duplex printing is selected in Step S101, printer driver 23 may proceed to Step S601 to execute a blank page recovery process.

FIG. 14 depicts a flow of the above-described blank page recovery process.

In Step S701, printer driver 23 may select a top page of a plurality of pages as a page of interest.

In Step S702, printer driver 23 may determine whether the page of interest is a last page of a chapter. If the page of interest is not a last page, the procedure may proceed to Step S703. If the page of interest is a last page, this process may end and the procedure may return to the blank page insertion/output process.

In Step S703, printer driver 23 may determine whether a page attribute of the page of interest is the same as a page attribute of a next page. If the page attributes are the same, printer driver 23 may determine that a blank page has been removed from therebetween, and the procedure may proceed to Step S704. If page attributes are different from each other, the procedure may proceed to Step S705.

In Step S704, printer driver 23 may insert a blank page between the page of interest and the next page, and may attach to the inserted blank page a page attribute different from that of the page of interest.

In Step S705, printer driver 23 may select a next page as a page of interest.

The blank page insertion/output process of the fourth illustrative embodiment may be substantially the same as the blank page insertion/output process of the first illustrative embodiment, except that a blank page recovery process is performed in Step S601 and that the two-page spread designation process of Step S105 is not performed. Further, the blank page insertion process of the fourth illustrative embodiment may be substantially the same as the blank page insertion process of the first illustrative embodiment, except that a determination of whether each page is to be printed on a front side of a sheet or to be printed on a back side of a sheet is made based on a page attribute attached to the page.

According to the fourth illustrative embodiment described above, if a top page of a chapter is to be printed on a back side of a sheet, printer driver 23 may insert a blank page at the top of the chapter, and also may insert a blank page at the end of a previous chapter. It is possible to maintain the form of a spread in the case of performing duplex printing of a plurality of pages in one batch.

### Other Embodiments

The present invention may not be limited to the illustrative embodiments that have been described above with reference to the accompanying drawings. Illustrative embodiments as described below may fall within the technical scope of the present invention, for example.

(1) In the first illustrative embodiment, the description has been given of the example in which, with respect to all the chapters, if a top page of the chapter is to be printed on a back side of a sheet, a blank page may be inserted at the top of the chapter. However, insertion of a blank page at the top of a chapter may be performed with respect to only a chapter including a two-page spread, if a top page of the chapter is to be printed on a back side of a sheet. For instance, in the case of the example shown in FIG. 2, a blank page may be inserted at the top of only the chapter 2.

In this way, it is possible to maintain the form of a spread in the case of performing duplex printing of only chapter 2 instead of performing duplex printing of a plurality of pages in one batch. It should be noted that, in this case, there is no need to insert a blank page at the end of the previous chapter. This is because, since the previous chapter will not be printed, insertion of a blank page at the end of the previous chapter is unnecessary for the purpose of maintaining the form of a spread in chapter 2.

Further, in this case, a blank page may be inserted at the end of only the previous chapter of the chapter including a two-page spread. In this way, in the case of performing duplex printing of a plurality of pages in one batch, with respect to at least the chapter including the two-page spread, it is possible to maintain the form of a spread while preventing a top page of the chapter and a last page of the previous chapter from being printed on front and back sides of one sheet.

Further, in the case of inserting a blank page at the end of only a previous chapter including a two-page spread, it may be determined whether a last page of the chapter including the two-page spread is to be printed on a front side of a sheet. If the last page is to be printed on a front side of a sheet, a blank page may be inserted at the end of the chapter. In this way, in the case of performing duplex printing of a plurality of pages in one batch, with respect to at least the chapter including the two-page spread, it is possible to maintain the form of a spread while preventing a top page of the chapter and a last page of the previous chapter from being printed on front and back sides of one sheet, and preventing the last page of the chapter and a top page of a next chapter from being printed on front and back sides of one sheet.

(2) In the first illustrative embodiment, the description has been given of the example in which, with respect to all the chapters, if a top page of the chapter is to be printed on a back side of a sheet, a blank page is inserted at the top of the chapter, and also a blank page is inserted at the end of a previous chapter. However, insertion of a blank page at the end of a previous chapter may be performed with respect to only a previous chapter including a two-page spread.

In this way, in the case of performing duplex printing of a plurality of pages in one batch, with respect to the chapter including the two-page spread, it is possible to maintain the form of a spread by inserting a blank page at the end of the previous chapter. On the other hand, with respect to chapters not including a two-page spread, if a top page of the chapter is to be printed on a back side of a sheet, a blank page is inserted at the top of the chapter, thereby preventing a page of the chapter and a page of a previous chapter from being printed on front and back sides of one sheet.

However, in this case, as for chapters not including a two-page spread, even if a blank page is inserted at the top of the chapter, a blank page is not inserted at the end of a previous chapter. As a result, pages of this chapter are not printed on the intended sides of sheets. However, since no two-page spread is included, although the pages of this chapter are not printed on the intended side of sheets, the resulting influence is small. On the contrary, since a blank page is not inserted at the end of the previous chapter, it is possible to make effective use of sheets.

(3) In the third illustrative embodiment, the description has been given of the example in which a determination of whether a page is supposed to be printed on a front side of a sheet or supposed to be printed on a back side of a sheet based on attribute information. However, for example, if the application program 22 outputs pages to the printer driver 23, it may be determined that a page that is output first is to be printed on a front side; a page that follows to be printed on a back side; another page that follows to be printed on a front side; and so on, based on the output order. This is because the application program 22 typically outputs a page to be printed on a front side and a page to be printed on a back side in this order.

(4) In the third illustrative embodiment, the description has been given of the example in which attribution information is attached to all the image data. However, attribute information may be attached to at least one image data. This is because, based on the side on which one image data is to be printed, the sides on which other image data to be printed can be determined.

(5) In the first illustrative embodiment, the description has been given of the example in which one blank page is inserted at the top of a chapter if a top page of the chapter is to be printed on a back side of a sheet, and one blank page is inserted at the end of the chapter if a last page of the chapter is to be printed on a front side of a sheet. However, the number of blank pages to be inserted is not limited to one.

For example, if a top page of a chapter is to be printed on a back side of a sheet, two blank pages may be inserted at the top of the chapter in Steps S306 and S311, and no blank page may be inserted at the end of the chapter in Step S309.

Or, conversely, no blank page may be inserted in Steps S306 and S311, and two blank pages may be inserted at the end of the chapter in Step S309.

That is, a last page of a previous chapter is to be printed on a front side of a sheet and a top page of the following chapter is to be printed on a back side of the sheet, two (or an even number of) blank pages may eventually be inserted between these chapters.

(6) In the above-described illustrative embodiments, the description has been given of the example in which a blank page is inserted at the top of a chapter or at the end of a chapter. However, a page break command may be inserted in place of a blank page. Insertion of a page break command can attain the same result as in the case of insertion of a blank page. In this case, the page break command is an example of a “page” that may be inserted at the top or the end of a chapter.

(7) In the above-described illustrative embodiment, the printer driver 23 is described as an example of the page processing program. However, the page processing program may be implemented as the application program 22. In this case, the process of previewing pages with a blank page inserted therein and a process of outputting the pages to the printer driver 23 are examples of the output process.

(8) In the above-described illustrative embodiments, a PC has been described as an example of the information processing apparatus. However, the information processing apparatus may be implemented as a mobile information terminal, a printer, a scanner, a facsimile machine, or a so-called multifunction apparatus having a copier function, a scanner function, a printer function, etc.

(9) In the above-described illustrative embodiments, the description has been given of the example in which the CPU 10 functions as a break position information acquisition unit, a page information acquisition unit, and so on, by executing the printer driver 23. However, these units may be implemented as a plurality of CPUs or ASICs.

(10) One aspect of the disclosure may be stated as follows:

“A page processing program, wherein, on a basis that an earlier one of two pages constituting a pair indicated by two-page spread information is to be printed on a back side of a sheet and a later one of the two pages is to be printed on a front side of a next sheet, it is determined, with respect to all page groups, whether a top page of the page group is to be printed on a back side of a sheet; and if the top page is to be printed on a back side of a sheet, a page is inserted at a top of the page group, and another page is inserted at an end of a previous page group of the page group.”

(11) Another aspect of the disclosure may be stated as follows:

“A page processing program that causes an information processing apparatus to execute:
a break position information acquisition process of acquiring break position information indicating a break position where a plurality of pages arranged in a printing order is divided into two or more page groups;
a front/back determination process of determining whether each of the pages is supposed to be printed on a front side of a sheet or supposed to be printed on a back side of a sheet if the plurality of pages are printed on both sides of sheets; and
a page insertion process of determining whether a top page of the page group is to be printed on a back side of a sheet based on a determination result obtained by the front/back determination process, and inserting a page at a top of the page group and another page at an end of a previous page group of the page group if the top page is to be printed on a back side of a sheet.”

What is claimed is:

1. A computer readable storage device storing a page processing program that, when executed by an information processing apparatus, causes the information processing apparatus to:
acquire two-page spread information indicating a pair of pages to be printed on successive back and front sides of separate sheets of recording media;
associate, based on the two-page spread information, a top page of a first page group including the pair of pages with a front side or a back side of a recording medium such that the pair of pages is set to be printed on successive back and front sides of separate sheets of recording media;
determine whether the top page has been associated with a back side of a recording medium; and
insert a page at a top of the first page group in a case that the top page is determined to be associated with the back side of the recording medium.

2. The computer readable storage device according to claim 1, wherein the page processing program, when executed by the information processing apparatus, further causes the information processing apparatus to:
acquire break position information indicating a break position where pages arranged in a printing order are divided into at least two page groups including the first page group and a second page group preceding the first page group;
associate a last page of the second page group with a front side of a recording medium in a case that the top page of the first page group is associated with the back side of the recording medium; and
insert a page after the last page of the second page group in a case that the last page of the second page group is associated with the front side of the recording medium.

3. The computer readable storage device according to claim 1, wherein the page processing program, when executed by the information processing apparatus, further causes the information processing apparatus to:
associate, based on the two-page spread information, a last page of the first page group with a front side or a back side of a recording medium; and
determine whether a last page of the first page group is associated with a front side of a recording medium; and
insert a page after the last page of the first page group in a case that the last page of the first page group is determined to be associated with a front side of a recording medium.

4. The computer readable storage device according to claim 1, wherein the page processing program, when executed by the information processing apparatus, further cause the information processing apparatus to:
acquire break position information indicating a break position where pages arranged in a printing order are divided into at least two page groups including the first page group and a second page group preceding the first page group;
associate, based on the two-page spread information, a last page of the second page group with a back side of a recording medium;
determine whether the second page group includes one page; and
insert a page at a top of the second page group in a case that the second page group is determined to include one page.

5. The computer readable storage device according to claim 1, wherein the page processing program, when executed by the information processing apparatus, further causes the information processing apparatus to:
acquire break position information indicating a break position where pages arranged in a printing order are divided into at least two page groups including the first page group and a second page group;
associate, based on the two-page spread information, a top page of each page group with a front side or a back side of a recording medium;
determine whether a top page of each page group is associated with a back side of a recording medium; and
insert an even number of pages between each page group and a previous page group when the top page is determined to be associated with a back side of a recording medium.

6. The computer readable storage device according to claim 2, wherein the page processing program, when executed by the information processing apparatus, further causes the information processing apparatus to:
acquire the break position information from the pages when the pages are received with break position information being attached thereto.

7. The computer readable storage device according to claim 2, wherein the page processing program, when executed by the information processing apparatus, further causes the information processing apparatus to:
acquire the break position information by receiving a user designation of the break position.

8. The computer readable storage device according to claim 1, wherein the page processing program, when executed by the information processing apparatus, further causes the information processing apparatus to:
acquire the two-page spread information from the pages when the pages are received with the two-page spread information being attached thereto.

9. The computer readable storage device according to claim 1, wherein the page processing program, when executed by the information processing apparatus, further causes the information processing apparatus to:
acquire the two-page spread information by receiving a user designation of the two-page spread.

10. The computer readable storage device according to claim 1, wherein the page processing program, when executed by the information processing apparatus, further causes the information processing apparatus to:
output the pages after the insertion of the page at the top of the first page group.

11. The computer readable storage device according to claim 1, wherein the page processing program, when executed by the information processing apparatus, further causes the information processing apparatus to:
display a preview screen showing the first page group with a page inserted therein after the insertion of the page at the top of the first page.

12. A computer readable storage device storing a page processing program that, when executed by an information processing apparatus, causes the information processing apparatus to:
acquire break position information indicating a break position where pages arranged in a printing order are divided into at least two page groups including a first page group and a second page group, which succeeds the first page group serially;
perform a front/back determination process by determining whether each of the pages is to be printed on a front side of a recording medium or to be printed on a back side of a recording medium for duplex printing;
determine whether a top page of each page group is to be printed on a back side of a recording medium based on the front/back determination process; and
insert an even number of pages between the first page group and the second page group divided according to the break position information when the top page of the second page group is to be printed on a back side of a recording medium.

13. The computer readable storage device according to claim 12, wherein the page processing program, when executed by the information processing apparatus, further causes the information processing apparatus to:
acquire image data from an image scanning apparatus that generates image data by scanning both sides of the pages arranged in the printing order; and
associate each page with attribute information indicating that the image data is generated by scanning a front side of one of the pages or that the image data is generated by scanning a back side of one of the pages,
wherein the front/back determination process determines whether each page is to be printed on a front side of a recording medium or on a back side of a recording medium based on the attribute information.

14. The computer readable storage device according to claim 13, wherein the page processing program, when executed by the information processing apparatus, further causes the information processing apparatus to:
determine whether the attribute information of a first page and a second page are the same;
insert a page between the first page and the second page when the attribute information of the first page and second page are the same; and
associate attribute information to the inserted page, wherein the attribute information associated with the inserted page is different from the first page.

15. An information processing apparatus, comprising:
a processor;
a memory storing a page processing program that, when executed by the processor, causes the information processing apparatus to:
acquire two-page spread information indicating a pair of pages to be printed on successive back and front sides of separate sheets of recording media;
associate, based on the two-page spread information, a top page of a first page group including the pair of pages with a front side or a back side of a recording medium such that the pair of pages is set to be printed on successive back and front sides of separate sheets of recording media;
determine whether the top page has been associated with a back side of a recording medium; and
insert a page at a top of the first page group in a case that the top page is determined to be associated with the back side of the recording medium.

16. The information processing apparatus according to claim 15, wherein the page processing program, when executed by the processor, further causes the information processing apparatus to:
acquire break position information indicating a break position where pages arranged in a printing order are divided into at least two page groups including the first page group and a second page group preceding the first page group;
associate a last page of the second page group with a front side of a recording medium in a case that the top page of the first page group is associated with the back side of the recording medium; and
insert a page after the last page of the second page group in a case that the last page of the second page group is associated with the front side of the recording medium.

17. The information processing apparatus according to claim 15, wherein the page processing program, when executed by the processor, further causes the information processing apparatus to:
associate, based on the two-page spread information, a last page of the first page group with a front side or a back side of a recording medium; and
determine whether a last page of the first page group is associated with a front side of a recording medium; and
insert a page after the last page of the first page group in a case that the last page of the first page group is determined to be associated with a front side of a recording medium.

18. The information processing apparatus according to claim 15, wherein the page processing program, when executed by the processor, further cause the information processing apparatus to:
acquire break position information indicating a break position where pages arranged in a printing order are divided into at least two page groups including the first page group and a second page group preceding the first page group;
associate, based on the two-page spread information, a last page of the second page group with a back side of a recording medium;
determine whether the second page group includes one page; and
insert a page at a top of the second page group in a case that the second page group is determined to include one page.

19. The information processing apparatus according to claim 15, wherein the page processing program, when executed by the processor, further causes the information processing apparatus to:
acquire break position information indicating a break position where pages arranged in a printing order are divided into at least two page groups including the first page group and a second page group;
associate, based on the two-page spread information, a top page of each page group with a front side or a back side of a recording medium;
determine whether a top page of each page group is associated with a back side of a recording medium; and
insert an even number of pages between each page group and a previous page group when the top page is determined to be associated with a back side of a recording medium.
